(19) United States
(12) Patent Application Publication
(10) Pub. No.: US 2017/0048614 A1
(43) Pub. Date: Feb. 16, 2017

(54) Corrections for Transducer Deficiencies

(71) Applicants: GARTH W. GOBELI, Albuquerque, NM (US); STEPHEN L. MILLS, Albuquerque, NM (US); JEAN S. GOBELI, Albuquerque, NM (US)

(72) Inventors: GARTH W. GOBELI, Albuquerque, NM (US); STEPHEN L. MILLS, Albuquerque, NM (US); JEAN S. GOBELI, Albuquerque, NM (US)

(21) Appl. No.: 14/825,731

(22) Filed: Aug. 13, 2015

(51) Int. Cl. H04R 3/04

(52) U.S. Cl. CPC H04R 3/04; H04R 2499/11; H04R 2430/01

(57) ABSTRACT

We describe a straightforward method/device that provides the “ideal” compensation to small micro-speaker acoustic transducers, such as those in current large-scale use in earbud headphones. This compensation results in an audio transducer that provides an output that precisely reproduces the input sound quality to the listener. The transducer thus has a “flat” reproduction for input sound; i.e. the reproduction is linear and independent of the sound frequency over a designated frequency range such as 20 Hz to 20,000 Hz. Applications for music appreciation and for speech comprehension enhancement for mobile phone communications are discussed.

### CROSS REFERENCE TO RELATED APPLICATIONS

This is a Continuation in Part to application Ser. No. 14/624,126: Filing Date: Feb. 17, 2015: Confirmation No: 5289: Attorney Docket No: GOBELI004.

### STATEMENT REGARDING FEDERALLY SPONSORED R&D

None.

### NAMES OF PARTIES TO A JOINT RESEARCH AGREEMENT

None.

### STATEMENT REGARDING PRIOR DISCLOSURES

None.

### FIELD OF THE INVENTION

This invention corrects the deficiencies in hearing that are introduced by the large non-uniformities in earbud micro-transducer sound response as a function of audio frequency.

There are many patents that relate to “equalizer” functions for sound detection (via microphones), sound transmissions (telephones), sound recordings (MP3 players, etc.), and sound reproduction (amplifiers and speakers). Of these elements, the reproduction of sound by audio transducers, such as speakers, are the root cause of the non-ideal reproduction of sound, both music and speech.

The major focus of “speaker” corrections has been via the use of speakers of different sizes and configurations with “crossover networks” being used to meld the speakers together into a single comprehensive unit.

Some control of the sound perceived by individuals is provided by “graphic equalizers” that permit the user to emphasize “high”, “midrange” and “bass” regions of these multi-speaker systems to suit themselves.

Some patents have been recently directed to improving the sound quality of mobile phones.

U.S. Pat. Nos. 6,011,853, 7,877,116, 8,218,756, and 8,473,911 show approaches that are user-controlled in their embodiment. They also are concerned about corrections related to non-uniformities of microphone imperfections in conversion of incident sound into an analog voltage and its subsequent conversion to a digital signal.

Additionally there are numerous active US Patent Applications that relate to this subject. US Patent Application Numbers US 2013/0097510, US 2012/0231851, US 2008/0013752, US 2010/0029337, US 2009/0061944, and US 2008/0096515 describe either self-adapting or user controlled adaptor-equalizer devices and/or methods.

All prior art describes the changes to be implemented, as being an “equalizer”. The definition of the term “equalizer” explicitly and implicitly is designed so that the user/listener can change the effects provided by the “equalizer” to provide their individually desired sound output. Also, conventional “equalizers” have corrections of 12 dB or less at any frequency.

U.S. patent numbers U.S. Pat. No. 6,553,126 and U.S. Pat. No. 7,505,603 describe the details of micro-speaker design and fabrication. They emphasize that this class of instruments is significantly different from “generally known speakers” in design, fabrication, and functionality. We shall designate the various sound output devices used in earbuds and mobile phones as “sound transducers”.

### SUMMARY OF THE INVENTION

We describe a straightforward method/device that provides the “ideal” compensation to small micro-speaker acoustic transducers, such as those in current large-scale use in earbud headphones. This compensation results in an audio transducer that provides an output that precisely reproduces the input sound quality to the listener. The transducer thus has a “flat” reproduction for input sound; i.e. the reproduction is linear and independent of the sound frequency over a designated frequency range such as 20 Hz to 20,000 Hz. The resultant method/device described in this patent is explicitly “firmware” and as such cannot be modified or changed by a user.

### BRIEF DESCRIPTION OF THE DRAWINGS

FIG. 1. A graph of the measured frequency response of typical earbud headset micro-transducers.

FIG. 2. Shows the analog representation of the device/method of this disclosure for frequency correction of earbud transducers to provide a “flat” frequency response.

FIG. 3. Shows the digital signal processor (DSP) embodiment of the correction of the transducer shown in FIG. 1.

FIG. 4. The graph of the frequency response of a mobile phone earpiece transducer showing the frequency locations of speech components as located in the voice speech range of 200 Hz to 8000 Hz.

FIG. 5. Shows the correction of the mobile phone acoustic transducer when the earbud transducer is connected to the hands-free port.

### DETAILED DESCRIPTION OF THE INVENTION

Earbud transducers/micro-speakers are of a completely different construction than that of conventional speaker-coil and cone-shaped suspension speakers, regardless of the speaker's size.

These earbud transducers all have a frequency response that is characterized by a resonance peak of maximum response; near 4000 Hz for high quality small transducer drivers (9 mm-10 mm). The response then declines both toward lower frequencies and higher frequencies.

Similar but more pronounced deficiencies in the earpiece micro-transducers of smartphones and landline handset earpiece transducers exist. The ideal frequency response curve of all acoustic transducers is a “flat”, frequency independent straight line as a function of sound frequency.

Modifications used for smartphones and landline phones discussed here will describe accommodation for the limited sound transmission bandwidth of all mobile and land line phones.

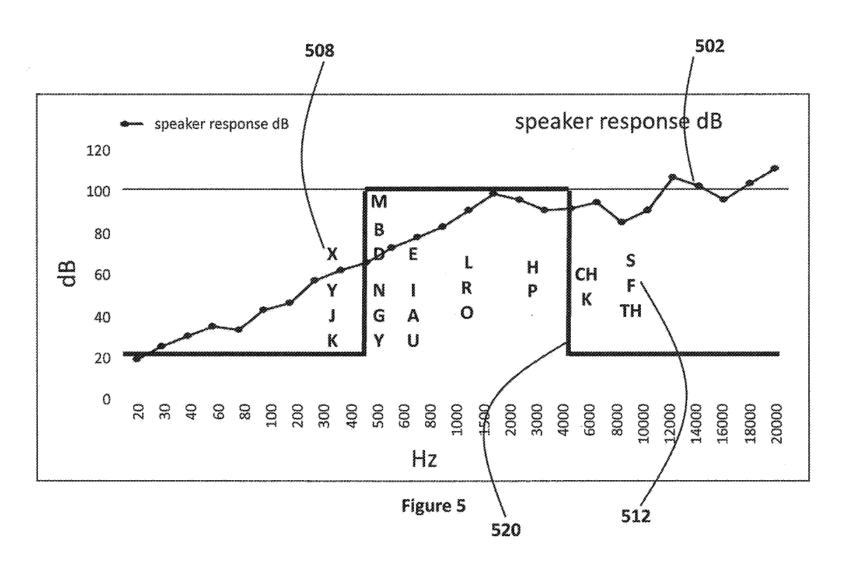

In addition the limitations of the “U.S. telephone system” are imposed as an instrumentation filter. The speech sounds within the “US” bandwidth are shown in FIG. 5 and the “Top Hat” correction provided by the DSP correction is shown.

### Definitions:

Transducer: A device that senses an acoustic sound wave and converts variations in a physical quantity, such as sound pressure, into an electrical signal. Conversely, a device that converts an electrical signal into an acoustic sound wave is an acoustic transducer

Earbud: A small acoustic transducer that fits into or on the ear for listening to sound, be it music or speech. Such transducers are called micro-transducers or micro-speakers

Earpiece transducer: A small transducer positioned in a mobile phone or landline phone that provides speech sounds to the user. In mobile phones these are small rectangular micro-transducers.

Analog circuit: An instrument comprised of analog electronic components; capacitors, inductors, resistors, and discrete solid-state electronic devices.

DSP; Digital Signal Processor; a circuit composed of digital signal storage registers, digital data processors, etc.

Why (Use) Earbuds?

The zero dB level of hearing is defined as 1×10⁻¹² Watts/Meter². A 90 dB sound level thus is 1×10⁻¹²×1×10⁺⁹=1×10⁻³ Watts/Meter² or 1 milli Watt/Meter².

The ear canal is about 7 mm in diameter so it is about 40 mm² in area. This is 4*10⁻⁵ Meter². Therefore less than about 10⁻⁷ Watts total acoustic power is needed/used to produce 90 dB sounds in the ear canal.

The efficiency for acoustic transducers (including micro-transducers) in producing sound from electronic excitation is less than 10⁻⁴. Thus only about 0.001 Watts of electrical power is needed to produce the 90 dB sound.

This low power requirement for earbud sound also demonstrates why modest size Lithium polymer batteries can power the use of earbuds for many (>24) hours. It also explains why modification of the earbud speaker response characteristics can be implemented with very modest power requirements.

The small micro-transducers used in earbuds (and cell phone earpiece speakers) for sound show a “resonance” near 4000 Hz. The response for higher frequencies exhibits a modestly changing response of about 25 dB). The response for lower frequencies shows a continuous drop off of that declines by as much as 30 dB at 400 Hz and up to 40 dB at 20 Hz. We discuss the use of corrected earbud micro-transducers for alleviating this problem for music listening from all sources, including MP3 players, and for voice communications of all telephones, both mobile and landline.

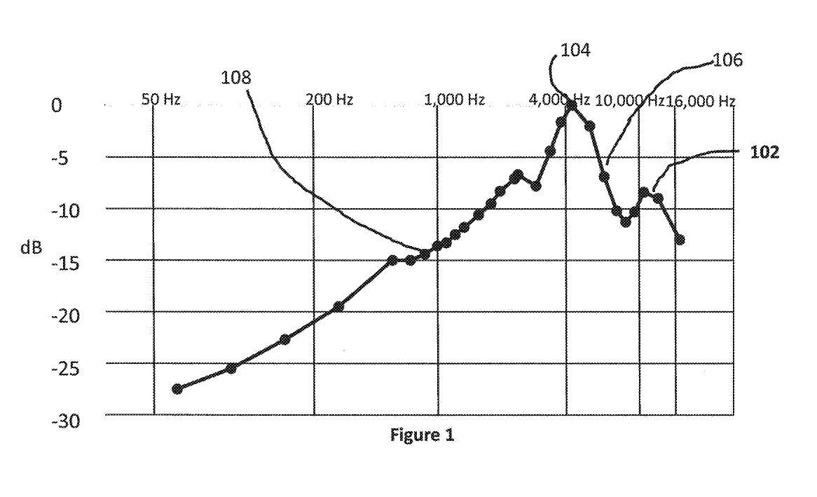

The sound quality delivered by both mobile phones and landline phones is compromised by the frequency response of the micro transducers used in their sound production. The earbud-transducer frequency response is shown in FIG. 1 (102) and is characterized by having a central damped resonant peak at the fundamental mechanical resonance (104) near 4000 Hz. The output response then declines for both higher (106) and lower (108) frequencies). We have measured this frequency response function for many earbud transducers, from the cheap to the very expensive, and find they all have their frequency response maxima at 3000 Hz4100 Hz. The response then declines by more than 20 dB at higher frequencies (20,000 Hz) and by more than 30 dB at lower frequencies (20 Hz). This behavior results in a distorted sound output, whether it is music or speech.

The ideal frequency characteristic is one that is completely frequency independent. Such a characteristic would be a flat horizontal line such as the “zero” line passing through the response curve (102) near 4000 Hz (110) of FIG. 1. Such a “flat” characteristic is also the objective of conventional room sized audio high-fidelity speaker systems.

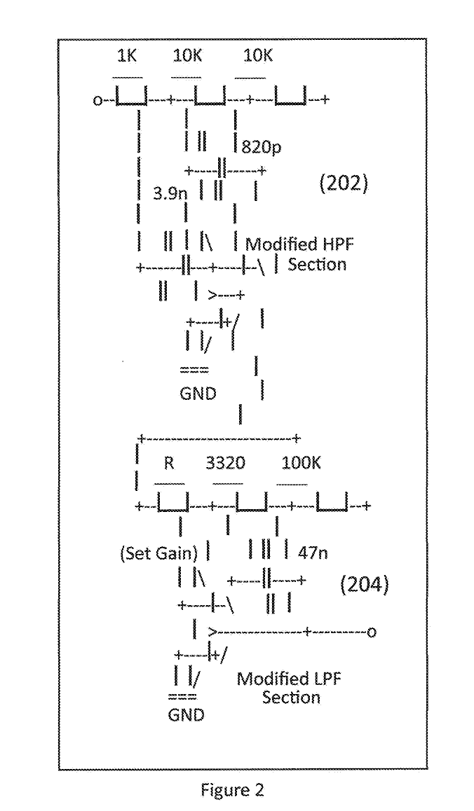

We have designed (and fabricated), an analog electronic system, shown in FIG. 2, which is the analog representation of the new circuit. The three components (202) are a meshed set of high pass shelf filters for corrections above 4000 Hz. The lower set of three shelf filters (204), are low pass filters for corrections at frequencies below 4000 Hz. The corrected earbud response demonstrates that the output is basically frequency independent from 20 Hz to 20,000 Hz. We have named this system μFi (micro fidelity).

The remarkable and unique feature of this μFi system is that the entire frequency range from 20 Hz to 20,000 Hz, (a ten octave range), offers full correction with up to 40 dB of amplification by using a single acoustic transducer. No complex “cross over networks” or any other extraneous passive or active components are needed. The analog system, comprised of a set of meshed “shelf” filters, provides a basically “flat” frequency response over the complete frequency range from 20 Hz to 20,000 Hz.

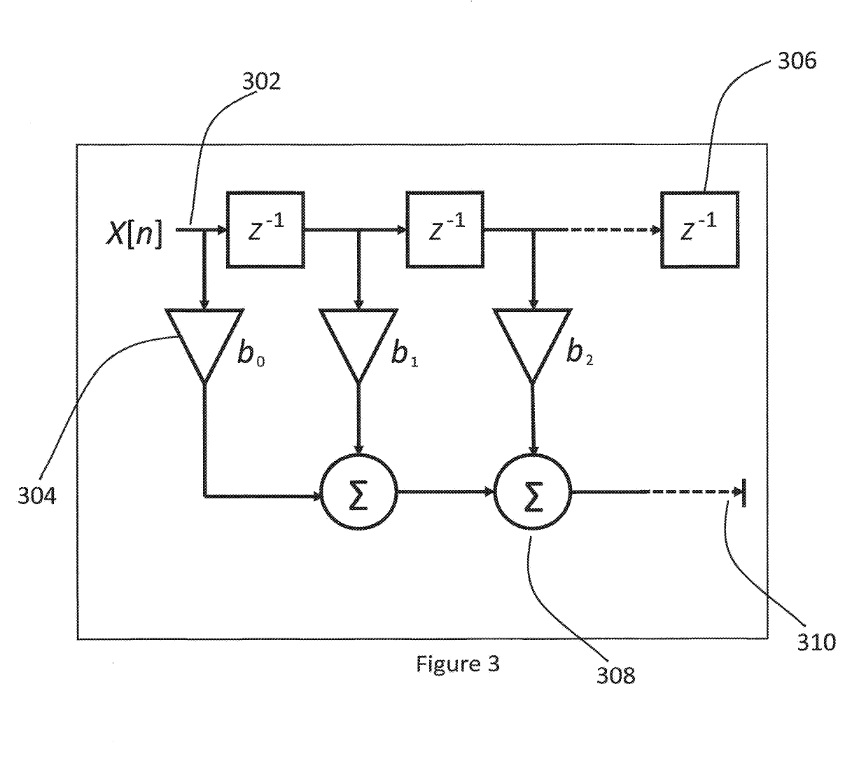

FIG. 3 shows the digital signal processing (DSP) approach to replicating the same frequency response for the acoustic transducer that is implemented by the analog circuit of FIG. 2. We have implemented the FIR (Finite Impulse Response) filter (FIG. 3), so as to replicate the frequency response of the analog circuit. In the digital domain, an FIR filter is a series of coefficients bi (304) with which the input signal (302) is convolved. The result is a filtered output signal (310) which has the appropriate frequencies boosted. X[n] (302) is the time sampled input signal. B=[b0,b1,b2, . . . bn] is the FIR filter coefficient set (308). Y[n] (310) is the time-sampled output of the FIR filter.

The analog representation of FIG. 2 has been replicated in the digital signal processor (DSP) embodiment as shown in FIG. 3. Measurements on this DSP embodiment yield the same result, i.e. it is “flat” with respect to acoustic frequency.

Requirements of the FIR digital system can require some time delays in output for very low frequencies, such as 20-80 HZ since several cycles of sampling are needed for precise correction. There are (at least) two approaches for relief for this situation. (1) Use a small analog section to provide the bulk of the needed correction. This can be derived directly from the analog system of FIG. 2. (2) An infinite impulse response (IIR) digital approach for this frequency range can be implemented.

There is a fundamental tradeoff between accuracy of response and the number of filter coefficients. The more coefficients you have, the closer the frequency response of the digital filter represents the frequency response of the analog filter. However, the more coefficients, the more processing is required, which in turn requires more power. With 128 coefficients, the response of the digital filter closely replicates the response function of the analog filter. This “precise” correction DSP characteristic shown in FIG. 3, resulted in an improved “flat” response of the earbud transducer (110).

The amplification needed to effect the desired “flat” response is determined from the native transducer frequency response (FIG. 1.). For each frequency, the decline in the response from zero (the value normalized at the resonance peak) to the measured value is determined. For example at 200 Hz the indicated value of 18 dB defines the needed amplification at 200 Hz. This set of amplification factors as a function of frequency is the “transfer function” of the system.

Since the DSP circuitry operates at a quite low voltage of 1.3 volts; it is necessary to provide power amplification circuitry so that sufficient power is available to provide the large amplifications required by the corrections. A digital to analog converter (DAC) followed by a class C pulse-width-modulated amplifier circuit powered by a 3.7 volt Lithium-Polymer battery was used.

Alternatively, a digital class D amplifier can be used directly, provided the transducer has sufficient battery voltage available for full amplification.

This innovative product can be configured as a unit with both the earbuds, together with a small DSP conditioning element, and powered by a small lithium-polymer battery. Connection to the sound source (mobile phone, MP3 player, etc.) is via a wireless connection (Bluetooth) or by a wired connection from the earbuds. Alternatively, it can serve as a conditioning system that is ready for the user's earbud set to be connected. Connection to the music or other sound source is via a corded connection or via a Bluetooth wireless connection. The power amplification of 35 dB is realized by use of a DAC followed by a class C pulse width modulation (PWM) amplifier component. Alternatively a class D digital amplifier can be used directly. The DSP processor has been found to be used 14% of the time and thus operates at quite low power.

This correction system works for any earbud set regardless of its price. Subjective tests of the μFi involving people listening to classical music from an MP3 player directly with earbuds and then with μFi activated were carried out. The results were described as “dramatic” improvements in sound quality. It also greatly improves the sound characteristic of earbuds having multiple drivers.

### Speech Comprehension Enhancement for Mobile Phones

The earbud correction of the audio transducers using the analog system or by using the digital modification and amplifier can be connected to the hands-free port of a mobile phone and, when connected, will provide an enhanced voice sound to the user. This is because the connection of the enhanced earbuds to the hands-free port disables the mobile phone earpiece speaker and transfers the sound to the modified earbuds. Even with the limited bandwidth for voice transmission (400 Hz to 3400 Hz in the U.S.A.) the sounds, especially those enhanced from about 1100 Hz to the lower cut-off value of 400 Hz provide a significant improvement in speech comprehension, since those speech sounds are significantly attenuated by the transducer response.

Unlike previous patents addressing the issue of “equalization” for mobile phones we find that by far the earpiece transducer frequency response is the dominant factor that causes a serious speech comprehension problem, especially when convolved with the bandwidth limitation existing for all phones.

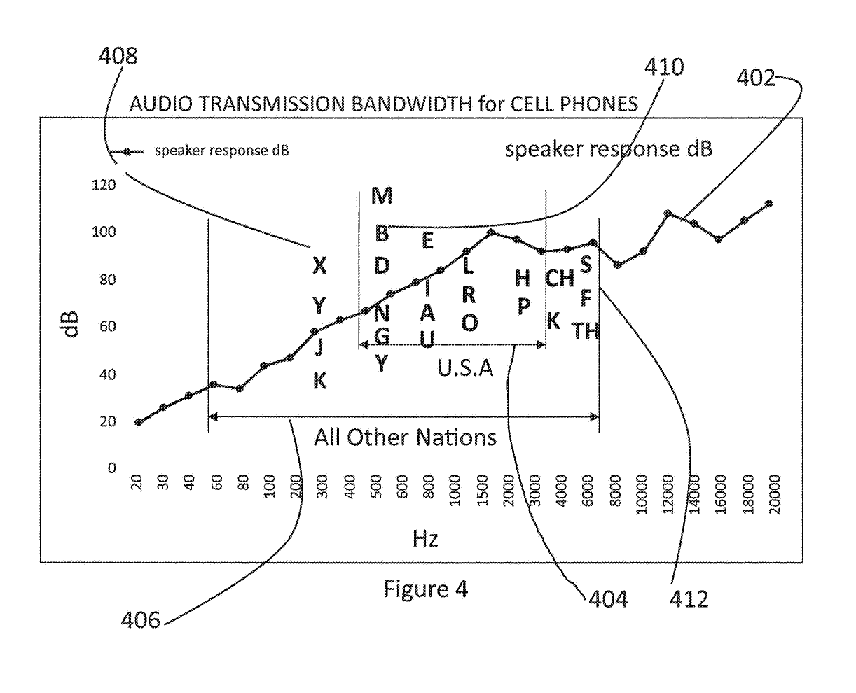

As shown in FIG. 4, the deviation from true linearity of the small rectangular output transducers is very large. The response curve (402) reaches a negative 90 dB for very low frequencies (20 Hz), 35 dB at 400 Hz, and plus or minus 10 dB for higher frequencies (from 1100 Hz to 20000 Hz).

This deficiency in the small rectangular earpiece transducers of smartphones is the significant feature that we address. In this case, the frequency range from 400 Hz to 3400 Hz is the domain of concern for mobile phone systems in the U.S.A.

By using this limited range, the DSP correction from 400 Hz (35 dB) to 3400 Hz (zero correction) is directly accessible and the corrections provide speech comprehension enhancement (SCE) in the optimum quality available for telephone communication.

Also in FIG. 4 are shown the frequency locations of normal speech sounds. Human speech covers the frequency range of about 250 Hz to 8,000 Hz. The sibilants sounds (S, F, TH (412)) are at 7,000 Hz to 8,000 Hz. These are the first sounds that are “lost” due to age-related hearing loss. The “fricatives” (CH, K) are next in line at 4500 Hz to 6500 Hz). The midrange consonants and vowel sounds (404) fill the region from 400 Hz to 3500 Hz. This region contains the majority of the speech sounds. This frequency region is the band-pass location of the U.S.A. voice transmission. The gutturals (X, J, K (408)) lie at about 250 Hz and are a minor part of speech comprehension.

Also shown in FIG. 4 is the mobile phone sound transmission band for systems in the U.S.A. (404) and for systems in all other nations (406). FIG. 4 illustrates that the compensation correction must reach 35 db at 400 Hz. This magnitude of compensation can be achieved only for a micro-transducer since really low voltages (less than 3 volts) have been shown to provide 80-90 dB amplification factors.

This restricted 3000 Hz wide frequency range is also present in landline telephones n the U.S.A. Since the frequency of normal speech ranges from a low value of about 100 Hz to about 8000 Hz, this restriction has a negative impact on speech comprehension. However only a few speech sounds reside below 400 Hz, notably the guttural consonants x, y, j, and k. Since these sounds make up only a very small fraction of speech the transducer correction provides significant improvements of speech comprehension even when limited by the U.S.A. transmission bandwidth.

The poor reproduction of sound over the 400 Hz-to-3400 Hz frequency bandwidth and the unmodified earhud frequency response further compromise the received speech sounds. By using μFi corrected earbuds it is found that speech comprehension is dramatically improved. For this situation, the improvement is due to the restoration of the lower frequencies (from 400 Hz to 1000 Hz). See FIG. 5 (520). The absence of the gutturals X,Y,J,K, (508) does not significantly impact speech recognition, although the gutturals do have a small assistance for some small class of words.

The “top hat” corrected response (520) includes both the transducer correction and the transmission bandwidth limitation. It shows an excellent reproduction of speech sounds over its entire range.

The approach given here provides well over 95% of the improvement in speech comprehension that is possible for mobile phone communications. The overall simplicity of the approach shows that the implementation cost and straightforward electronic implementation offer an excellent cost/reward solution/improvement for speech comprehension enhancement (SCE) for mobile and landline communication.

When the μFi enabled earbuds are plugged into the hands free port of a smartphone the speech comprehension enhancement of the cell phone is remarkably improved. This is simply because the “hands free” mode disables the built in smartphone speaker and switches use to the micro-fidelity corrected earbuds. The straightforward restoration of speech sounds in the frequency range from 1200 Hz to 400 Hz improves speech comprehension remarkably.

We claim as follows:

1. Correction of audio micro-transducers comprising, an earbud transducer having a response over the frequency range from 20 Hz to 20,000 Hz such that the response is independent of the acoustic frequency.

2. An audio micro-transducer according to claim 1, wherein the correction is implemented as an analog filtering system.

3. An audio micro transducer according to claim 1, further comprising a digital signal processor (DSP) followed by a class D digital amplifier.

4. An audio micro transducers according to claim 1 wherein the modifications are performed by a digital signal processor (DSP) and augmented by an analog component for boosting low frequencies.

5. An audio micro transducer according to claim 4, wherein the modifications are performed by the DSP circuit and followed by a digital-to-analog converter (DAC) with a class C analog amplifier in series.

6. An audio micro transducer according to claim 4, wherein the DSP circuit of claim 4 is programmable to account for different earbud transducer frequency response characteristics.

7. An audio micro transducer according to claim 1, wherein the modifications permit amplification correction values of zero to 40 dB at any frequency from 20 Hz to 20,000 Hz.

8. An audio micro transducer according to claim 1, wherein the correction cannot be altered by the user.

9. An audio micro transducer according to claim 1, wherein the frequency-corrected earbud transducers are connected to the hands-free port of a mobile phone by a wired connection, thereby providing a significantly improved speech/music sound for the user.

10. An audio micro transducer according to claim 1, wherein the frequency-corrected earbud transducers are connected to the hands-free port of a mobile phone via a wireless connection, known as a “Bluetooth” instrument, thereby providing a significantly improved speech/music sound for the user.

11. An audio micro transducer according to claim 1, wherein a corrected earbud transducer with DSP correction and a battery source is connected to a mobile phone via the hands-free port; the apparatus being fastened securely to the top edge of the mobile phone.

12. A corrected small earpiece audio micro-transducer that is used in communication equipment comprising; a frequency-independent transducer response over the frequency range from 200 Hz to 7,000 Hz.

13. A small earpiece audio micro transducer according to claim 12; wherein the correction is performed by a digital signal processor (DSP) followed by a class D digital amplifier.

14. A small earpiece audio micro transducer according to claim 12; wherein the correction is performed by a DSP circuit followed by a digital-to-analog converter (DAC) with a class C analog amplifier in series.

15. A small earpiece audio micro transducer according to claim 12; wherein amplification correction values of zero to 40 dB at any frequency from 200 Hz to 7,000 Hz are used.

16. A small earpiece audio micro transducer according to claim 12; wherein the correction may not be altered by the user.

17. A small earpiece audio micro transducer according to claim 12; wherein the corrections are performed by (new) programming of the DSP and audio amplifier components already present in said mobile phones.
